(19) United States
(12) Patent Application Publication
(10) Pub. No.: US 2013/0048740 A1
(43) Pub. Date: Feb. 28, 2013

(54) DEVICE, SYSTEM AND METHOD FOR IMPRINTING SYMBOLOGY ONTO A HUMAN FOR MEDICAL RECORD CORRELATION

(71) Applicant: Leigh M. ROTHSCHILD, Sunny Isles Beach, FL (US)

(72) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/287,350

(22) Filed: Nov. 2, 2011

Related U.S. Application Data
(60) Provisional application No. 61/529,021, filed on Aug. 30, 2011.

(51) Int. Cl. G06K 1/12; G06K 19/06

(52) U.S. Cl. 235/494

(57) ABSTRACT

A medical record keeping system, device and method are provided. The system includes a symbology device including a first processor. The first processor determines identification data corresponding to a patient and determines a code to imprint based at least in part on the identification data. At least a portion of the identification data is represented in the code. The symbology device includes a transmitter that transmits the identification data and patient data in which the identification data corresponds to patient data. The system may also include a server in communication with the symbology device. The server includes a receiver that receives the identification data and corresponding patient data. The server includes a memory that stores the identification data and corresponding patient data.

### CROSS-REFERENCE TO RELATED APPLICATION

This application is related to and claims priority to U.S. Provisional Patent Application Ser. No. 61/529,021, filed Aug. 30, 2011, entitled Device, System and Method for Imprinting Symbology Onto a Human for Medical Record Correlation, the entirety of which is incorporated herein by reference.

### STATEMENT REGARDING FEDERALLY SPONSORED RESEARCH OR DEVELOPMENT

n/a

### FIELD OF THE INVENTION

The present invention relates to medical records keeping and in particular to a device, system and method for storing medical data and linking the data to symbology imprinted onto a human.

### BACKGROUND OF THE INVENTION

The storage and retrieval of medical records is vital to providing high quality health care to patients. Currently, a physician may keep track of an existing patient's medical records through paper files and folders. For example, the physician may update a patient's folder containing medical charts and past medical exams and keep the folder stored in a file room. However, physical files stored in a file room are vulnerable to being misplaced or loss due to a clerical office error. The physical files in the file room are also vulnerable to natural disasters such as tornadoes and hurricanes in which one natural disaster can destroy the medical records of numerous patients.

Some physicians have begun to store these medical charts and past medical exams on a computer operated by the physician's personal. The database allows the physician to access a patient medical records during a routine visit in order to provide healthcare related services to the patient. However, a problem occurs when the patient visits a new doctor in which the new doctor requires the patient's past medical records in order to properly diagnose the patient. Often, the new doctor has to request the patient's medical records from the previous physician(s). The new doctor may not received the patient's medical records for weeks and will often require the patient come back for a follow up. This time consuming process often hinders efficient medical care.

Furthermore, in certain areas of the world, physicians often cannot afford to keep track of medical records associated with patients due to their limited resources. For example, in third world countries or in high poverty areas, medical files may be stored under conditions that may end up destroying the medical records, e.g., rodent infested locations or locations exposed to elements of nature. These physicians often cannot afford the expense of running a private database of medical records. The physicians may try to rely on the patients themselves to provide their medical history but often patients do not know or remember their specific medical history. For example, patients living in third world countries may not know or remember the kinds of vaccines they were given when they were children.

There is a need in the art for a device, system and method that allows reliable and accurate access to patients' medical records.

### SUMMARY OF THE INVENTION

The present invention advantageously provides a device, system and method for storing medical data and linking the stored medical data to symbology imprinted on a patient.

According to one embodiment, a symbology device is provided. The symbology device includes a processor that determines identification data corresponding to a patient and determines a code to imprint based at least in part on the identification data. At least a portion of the identification data is represented in the code. Symbology device includes an imprinter arranged to imprint the code onto the patient.

According to another embodiment, a system is provided. The system includes a symbology device including a processor. The processor determines identification data corresponding to a patient and determines a code to imprint based at least in part on the identification data. At least a portion of the identification data is represented in the code. The symbology device includes a transmitter that transmits the identification data and patient data in which the identification data corresponds to patient data. The system includes a server. The server includes a receiver that receives the identification data and corresponding patient data. The server includes a memory that stores identification data and corresponding patient data.

According to yet another embodiment, a method for imprinting symbology corresponding to patient data is provided. The method includes determining identification data corresponding to a patient and determining a code to imprint based at least in part on the identification data. At least a portion of the identification data is represented in the code. The method includes imprinting the code onto the patient.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of a system for storing medical data and linking the stored medical data to symbology constructed in accordance with the principles of the present invention;

FIG. 2 is a flow chart of an exemplary process for initiating the imprinting of symbology and storing the corresponding patient data;

FIG. 3 is a flow chart of an exemplary process for storing and retrieving patient data; and

FIG. 4 is a block diagram of an exemplary symbology device.

### DETAILED DESCRIPTION OF THE INVENTION

The present invention advantageously provides a system and method for storing medical data and linking the stored medical data to symbology.

Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

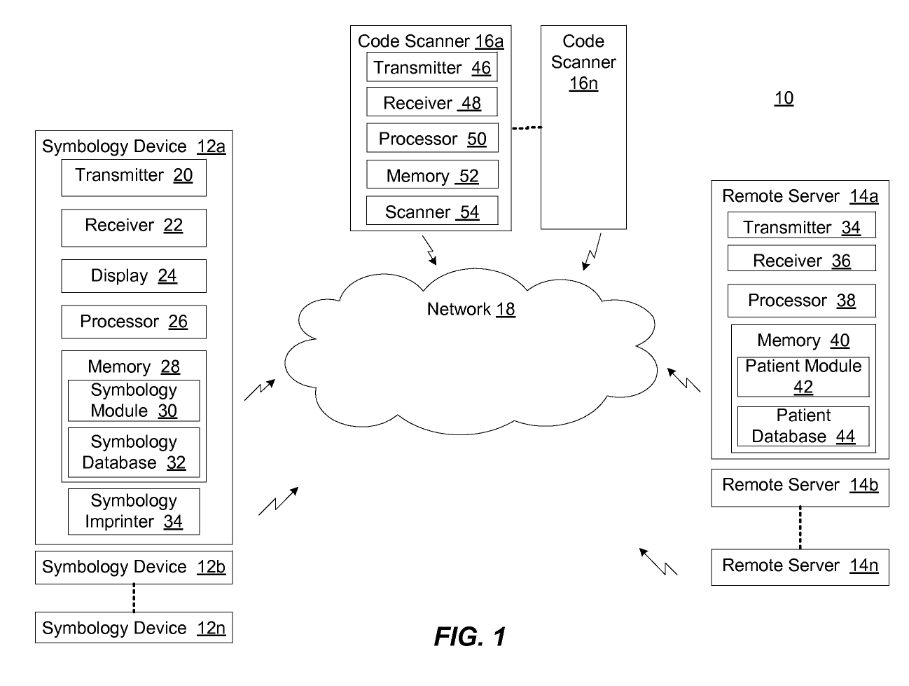

Referring now to the drawings figures in which like reference designators refer to like elements there is shown in FIG. 1 an exemplary medical record storage and linking system constructed in accordance with the principles of the present invention and designated generally as “10.” In particular, system 10 may form one or more cloud computing environments for storing identification (ID) data and corresponding patient data such as vaccination data, medical history data, among other data. Symbology refers to a code that is imprinted on/in a portion of a human being, other mammals or other creatures. System 10 includes one or more symbology devices 12a to 12n (collectively referred to as “symbology device 12”), one or more remote servers 14a to 14n (collectively referred to as “remote server 14”), one or more code scanners 16a to 16n (collectively referred to as “code scanner 16”), communicating via network 18. Network 18 may include wired and/or wireless data communication networks such as an Internet Protocol network, among other networks that allow for data communications. While symbology device 12 and code scanner 16 are shown as separate elements, they may also be incorporated into one device (not shown).

Symbology device 12 may be a mobile device, personal computer, laptop computer, tablet computer, PDA, among other types of computers. Symbology device 12 may include transmitter 20 and receiver 22 for communicating with code scanner 16 and/or remote server 14, via network 18. Display 24 may display information and/or the code to be imprinted to the patient. Display 24 may be a cathode ray tube (CRT) display, liquid crystal display (LCD), light-emitting diode (LED) display, touch screen display, among other types of displays. Processor 26 may include a central processing unit (CPU) for performing symbology device 12 functionality. Memory 28 may include symbology module 30, symbology database 32, among other modules and databases.

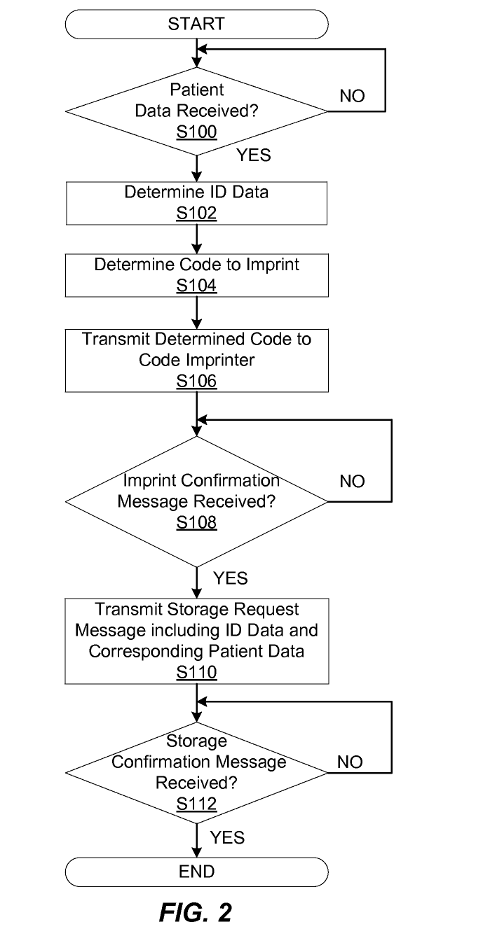

In particular, memory 28 may include a non-volatile and volatile memory. For example, non-volatile memory may include a hard drive, memory stick, flash memory and the like. Also, volatile memory may include random access memory and others known in the art. Symbology module 30 may be computer program instructions stored in memory 28, which when executed by processor 26, initiates imprinting of symbology and storing of corresponding patient data functions as discussed with respect to FIG. 2. Symbology database 32 may include a variety of codes that may be imprinted onto a living creature. The codes or symbologies may include one dimensional (1D) codes, two dimensional (2D) codes such as a MICROSOFT tag code, among other types of codes that may represent at least a portion of identification (ID) data. For example, the codes may be optical machine readable codes such as a series of parallel lines or a graphical drawing. For example, the code may be a drawing of a “happy face” such that ID data is represented (e.g., via barcode, characters) in the happy face, and the happy face is imprinted onto the living creature, as discussed in detail with reference to FIG. 2. Symbology device 12 may include a Global Positioning System (GPS) component or module that provides location/position and time information, among other GPS information. Symbology device 12 may be implemented using hardware or a combination of hardware and software.

Symbology imprinter 33 may include a mechanism for imprinting a code (i.e., symbology) on a portion of a human, other mammals, and other creatures. For example, symbology imprinter 33 may be a needle based ink injection mechanism, laser based mechanism, ultraviolet light based mechanism, among other types of mechanisms that may cause a permanent, semi-permanent or temporary imprint of the code on a portion of a living creature.

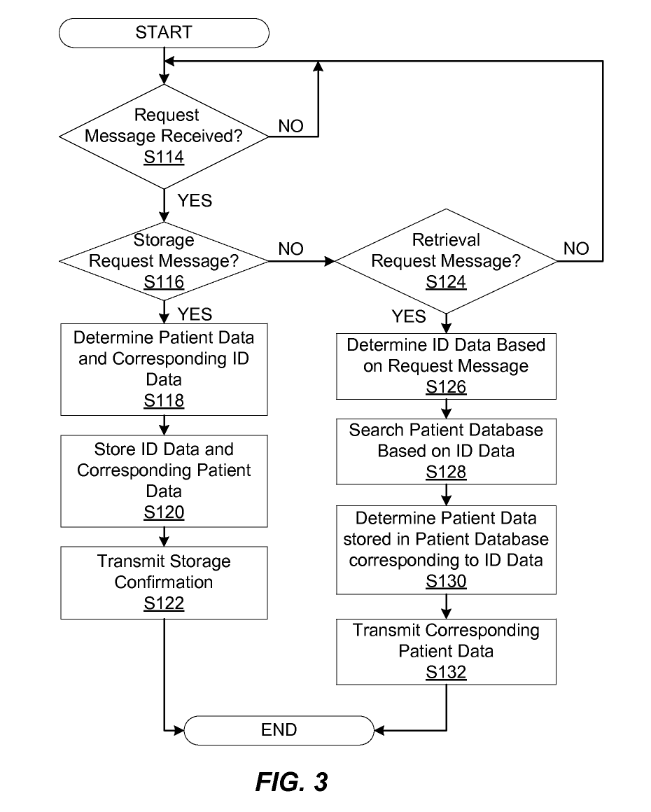

Remote server 14 may include transmitter 34, receiver 36, processor 38 and memory 40 that function substantially the same as the corresponding symbology device 12 components, with size and performance being adjusted based on design requirements. Memory 40 may include patient module 42 and patient database 44. In particular, patient module 42 includes instructions, which when executed by processor 38, causes processor 38 to store and retrieve patient data, discussed in detail with reference to FIG. 3.

Patient database 44 may include patient data for one or more patients and ID data corresponding to the patient data, e.g., each patient may have ID data and corresponding patient data. For example, patient data may include name, age, date of medical aid administration, vaccination history of patient, geographical location of patient, address, geographical location where medical aid was administered e.g., based on GPS information, vaccine lot number, other vaccine identifiers, patient medical history, among other patient information. In particular, patient database 44 associates particular patient data with ID data (e.g., patient identification number) such that a search of patient database 44 for specific ID data will return corresponding patient data, as discussed in detail with reference to FIG. 3. Of note, although the patent data is described herein as being stored in a “database”, the invention is not limited to storage in a formal database management system, e.g., SQL. It is contemplated that any memory storage device can store the patent data in an organized and retrievable form, e.g., flat file.

Code scanner 16 may be a mobile phone device, personal computer, laptop computer, tablet computer, personal digital assistant (PDA), among other types of devices that may include scanner 54. Alternatively, scanner 54 may be an attachment that may connect to code scanner via universal serial bus (USB), among other connections types. Code scanner 16 may include transmitter 46, receiver 48, processor 50 and memory 52 that may function substantially the same as the corresponding symbology device 12 components, with size and performance being adjusted based on design needs. In particular, memory 52 may include computer program instructions, which when executed by processor 50, cause processor 50 to operate scanner 54 to enable scanning and processing of the imprinted code. For example, scanner 54 may be a digital camera that is included in a mobile phone in which the digital camera captures on optical image of the imprinted code and reads/decodes the captured image for ID data. Alternatively, scanner 54 may include other types of scanners that scan or capture the imprinted code, e.g., laser scanner and charge-coupled device (CCD) reader.

An exemplary process for initiating the imprinting of symbology and storing of corresponding patient data corresponding to a patient is described with reference to FIG. 2. A determination is made whether patient data has been received (Step S100). For example, patient data may be input into symbology device 12 by a doctor or patient, via input mechanisms, e.g., keypad or keyboard, or some or all of the patient data may be received from a central server (not shown) that contains previously stored patient data. Continuing the example, patient data may be received from a healthcare provider's central server. If no patient data has been received, the determination of Step S100 may be repeated. Alternatively, a network administrator, doctor and/or patient may be notified (not shown). If the patient data is received, symbology device 12 determines the ID data corresponding to a living creature (patient), e.g., ID data corresponds to patient data specific to a patient (Step S102). ID data may include a patient ID number, name of patient, birth date of patient, digital images of the patient, patient password, among other data, e.g., may include patient data such as patient name. The ID data may be determined based in part on the geographical location of the patient, geographical location where medical aid is administered, identity of physician, among other criteria. For example, patient ID number (e.g., ID data) may be similar for patients located in the same geographical location or region. The ID data may be a string of characters strings such as alpha, numeric or alpha-numeric characters.

If the ID data is determined, symbology device 12 determines which code to imprint on the living creature, e.g., human patient (Step S104). The determined code to imprint may be based at least on the determined ID data. For example, the code may be determined based on the patient identification number. Continuing the example, a short patient identification number (e.g., 6 characters) may correspond to a 1D code (barcode) such that the imprinting time is minimized. Continuing the example, a long patient identification number, e.g., 20 characters, may correspond to a 2D code that requires less space to imprint than a 1D code using the same characters.

The determined code to imprint may be based at least in part on other factors such as geographical location of the patient, geographical location of symbology device 12, geographical based data, type of patient data, date of vaccination, type of vaccine, date code is imprinted, date medical aid is administered, size of identification (ID) data to be imprinted, medical history, vaccination history, size of patient data, type of patient data and/or other criteria. For example, certain codes may be specific to the geographic location of the patient such as continent, region or locality. Continuing the example, certain codes may be specific to geographic information (GPS information) provided by GPS component such as the geographic location where symbology device 12 is being used. Moreover, certain codes may be specific to the date medical aid is administered such as a year in which the vaccination was administered to the patient and/or certain types of vaccines may correspond to specific codes, e.g., Measles, mumps, rubella (MMR) vaccine may correspond to a specific 2D code in which the ID data is represented by the code. Type of patient data may correspond to sensitivity of patient data (e.g., highly personal patient data) and/or priority of patient data (e.g., high priority medical records such as past heart surgery and lower priority medical records such as a routine checkup).

The determined code to imprint may be based at least in part on inputs from the doctor and/or patient (e.g., another factor). For example, display 24 may display different types of codes that may be imprinted onto the patient in which the user or patient may select a code, via an input mechanism such as coding device button, touch screen button, voice command, mouse input device, among other input mechanisms. Continuing the example, the patient may prefer a 1D barcode as opposed to a 2D barcode such that a 1D barcode with ID data is imprinted onto the patient as discussed with respect to S106. Determining the code to imprint is not limited to these factors and may be based at least in part on other factors.

The determined code may be a graphical drawing. For example, the determined code may be a drawing of a “happy face” such that the ID data is included or represented by at least part of the drawing. Continuing the example, ID data may include patient ID number “110” that may be imprinted as part of the outline of the happy face. For example, a portion of the outline of the happy face may be replaced by the 1D barcode. Alternatively, patient ID number may be represented by the happy face itself such that each happy face drawing corresponds to specific ID data. For example, a closed eye on the happy face may represent a “1”, an open eye may represent a “0”, the variety of happy face mouth configurations may correspond to characters “000” to “999”, among other happy face characteristics that may correspond to a specific character(s). While the example includes a drawing of a happy face, other graphical drawings may be used in place of the happy face.

The determined code (e.g., symbology) may represent at least a portion of the ID data. In particular, the identification data may be imprinted directly onto or into the patient without changing the representation of the identification data. For example, patient identification number (e.g., ID data) of “123456” may be imprinted as “123456” on the patient as opposed to changing the representation of “123456” into a 1D code (e.g., barcode). The ID data may be readable by code scanner and/or a human without decoding, e.g., numeric numbers (ID data) imprinted onto patient such that they can be read by a doctor without code scanner 16. Alternatively, the determined code may be encoded with ID data (not shown). In particular, a one dimensional code maybe encoded with some or all of the ID data. For example, the ID data (e.g., patient ID number “110”) may be encoded such that the encoded ID data (e.g., encoded patient ID number “110110110”) is then included as part of the code. Using encoded ID data may provide added security in protecting the patient ID number and corresponding patient data. The code may be encoded with some or all of the patient data. For example, patient data such as patient name may be encoded into the code such that code scanner 16 is able to decode patient data based on the scanned code. Other patient data may also be encoded into the code. Continuing the example, ID data (e.g., patient number or encoded patient number) may also be included in the code along with the encoded patient data.

The determined code is transmitted to symbology imprinter 33 such that the code is imprinted onto the living creature, e.g., at least a portion of the ID data is represented in the code that is imprinted onto the living creature (Step S106). A determination is made as to whether an imprint confirmation message has been received indicating the code was successfully imprinted (Step S108). If it is determined no imprint confirmation message has been received, the determination of Step S108 may be repeated. Alternatively, a network administrator, doctor and/or patient may be notified (not shown). If an imprint confirmation message is received, the determined ID data and corresponding patient data may be transmitted to remote server 16 via a storage request message, e.g., ID data, corresponding patient data and/or other data may be transmitted to remote server 16 for storage, other data such as GPS information (Step S110).

The storage request message may include a password and/or login input by the patient or physician corresponding to ID data and/or patient data. For example, the password may be linked to ID data and patient data such that remote server 16 will only retrieve patient data when the password and corresponding ID data are received in the retrieval request message as discussed in detail with respect to FIG. 3. Continuing the example, the patient or doctor may enter a password into the code scanner that may be transmitted along with the patient data. A determination is made if a storage confirmation message has been received (Step S112). For example, the storage confirmation message may indicate successful storage of ID data and corresponding patient data in patient database 44 at remote server 14, e.g., storage in a cloud computing environment. The storage confirmation message is discussed in detail with respect to FIG. 3. If no storage confirmation message is received, the determination of Step S112 may be repeated. Alternatively, the network administrator, doctor and/or patient may be notified (not shown).

An exemplary process for storing and retrieving patient data is described with reference to FIG. 3. A determination is made whether a request message is received (Step S114). For example, a request message may be received from symbology device 12, code scanner 16, via a website, among other devices and/or interfaces. If it is determined no request message is received, the determination of Step S114 may be repeated. If it is determined that a request message is received, a determination is made whether the request message is a storage request message (Step S116). For example, a storage request message may indicate that ID data and corresponding patient data are to be stored in patient database 44, e.g., indicated by a triggered flag in the message. If it is determined that the receive request is a storage request message, the patient data and corresponding ID data in the storage request message are determined, e.g., process request message for ID data and corresponding patient data (Step S118). The storage request message may also include a password and login that corresponds to the ID data and/or patient data. For example, a password may be entered by the physician or patient via the input mechanism on symbology device 12 such that the ID data and/or patient data are linked to the password. The password may be composed of alpha, numeric or alpha-numeric characters. The password may provide added security such that at least the password and corresponding ID data are needed to recover patient data. The login may be a series of characters specific to a patient, doctor or other user. For example, the login may be a username such as the patient's last name followed by a number. The storage request message may include GPS information to be stored, e.g., GPS information from GPS component in symbology device 12 or GPS information received by symbology device 12. The determined ID data and corresponding patient data from the storage request message are stored in patient database 44 in which patient data is linked to the ID data (Step S120). For example, a flag or table may be updated in patient database 44 indicating specific ID data corresponds to specific patient data, among other specific data such as GPS information. A storage confirmation message may be transmitted upon successful storage in patient database 44 of the patient data and corresponding ID data (Step S122). For example, the storage confirmation message may be transmitted to the code scanner 14, symbology device 12, laptop computer, tablet computer, among other devices.

Referring back to Step S116, if it is determined the request message is not a storage request message, a determination is made whether the request message is a retrieval request message (Step S124). The retrieval request message may indicate specific patient data to be retrieved from patient database 44. If it is determined the request message is not a retrieval request message, the determination of Step S116 may be repeated. Alternatively, a network administrator, doctor and/or patient may be notified (not shown). If the request message is determined to be a retrieval request message, the ID data in the retrieval request message is determined, e.g., process retrieval request message for ID data (Step S126). For example, the retrieval request message may contain ID data such as a patient identification number that was transmitted by code scanner 16, among other data that may identify a patient.

A password and login may be included in the retrieval request message. For example, the password may be input, via the input mechanism on the code scanner, by the doctor and/or patient. A password offers added security in that only certain people who known the password may retrieve patient data corresponding to the ID data. Patient database 44 may be searched based on the determined ID data (e.g., patient identification number) from the retrieval request message, e.g., the patient data is retrieved based at least in part on the determined ID data (Step S128). The patient data corresponding to the determined ID data is determined (Step S130). If there is no corresponding patient data stored in patient database 44, a network administrator, doctor and/or patient may be notified, and/or another patient database may be searched (not shown). The determined corresponding patient data stored in patient database 44 may be transmitted (Step S132). For example, the determined corresponding patient data may be transmitted to code scanner 16, symbology device 12, among other devices capable of receiving patient data, e.g., patient data is transmitted to the device that transmitted the retrieval request message. All or a portion of the stored patient data may be transmitted. For example, the physician may only request a portion of patient data in which symbology device 12 may indicate this specific request in the retrieval request message.

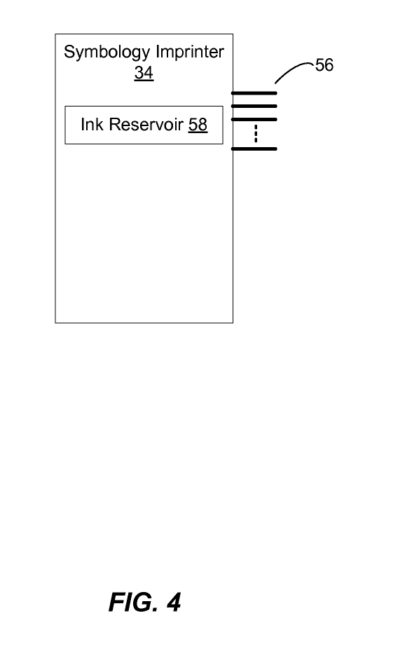

An exemplary symbology device 12 for imprinting symbology is described with reference to FIG. 4 in which reference elements of symbology device 12 are shown in FIG. 1. Symbology device 12 may use a needle based injection mechanism to imprint symbology onto a living creature. For example, one or more needles (“needle 56”) many inject ink into or onto a living creature. The ink may be visible under the visible light spectrum, under ultraviolet light spectrum, among under other lighting conditions. The ink may be stored in ink reservoir 58, e.g. ink is dispensed from ink reservoir 58 to needle 56. Alternatively, symbology device 12 may include other mechanisms for imprinting symbology onto a living creature. For example, symbology device 12 may imprint symbology (e.g., code) using a mechanism that forms bumps on the living creature similar to skin bumps found in tribal cultures. Symbology device 12 is not limited these types of imprinting mechanisms and may include other imprinting mechanism such as a laser based imprinting mechanism that uses one or more lasers to imprint symbology onto a living creature.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A symbology device, comprising:
a processor, the processor:
determining identification data corresponding to a patient;
determining a code to imprint based at least in part on the identification data, at least a portion of the identification data being represented in the code; and
an imprinter, the imprinter arranged to imprint the code onto the patient.

2. The device of claim 1, further comprising:
at least one of an input mechanism and receiver that receives patient data; and
a transmitter, the transmitter transmitting the identification data and patient data, the identification data corresponding to the patient data.

3. The device of claim 2, further comprising a receiver, the receiver receiving a storage confirmation message indicating that the identification data and corresponding patient data have been successfully stored.

4. The device of claim 1, wherein the code is at least a one dimensional code.

5. The device of claim 1, wherein the code is a graphical drawing, at least a portion of the identification data being represented in the graphical drawing.

6. The device of claim 1, wherein the code is based at least, in part, on one of a geographical location of the patient and date the code is imprinted.

7. The device of claim 1, wherein the imprinter includes a needle based injection mechanism to inject an ink into the patient.

8. The device of claim 1, wherein the ink is one of a first ink visible under a visible light spectrum and second ink visible under an ultraviolet light spectrum.

9. The device of claim 1, wherein the code is at least a two dimensional code.

10. A system, comprising:
a symbology device, the symbology device comprising:
a processor, the processor:
determining identification data corresponding to a patient;
determining a code to imprint based at least in part on the identification data, at least a portion of the identification data being represented in the code; and
a transmitter, the transmitter transmitting the identification data and patient data, the identification data corresponding to patient data; and
a server in communication with the symbology device, the server comprising:
a receiver, the receiver receiving the identification data and corresponding patient data; and
a memory, the memory storing identification data and corresponding patient data.

11. The system of claim 10, wherein the symbology device further comprises an imprinter, the imprinter arranged to imprint the code onto the patient.

12. The system of claim 11, wherein the code is a graphical drawing, at least a portion of the identification data being represented in the code.

13. The system of claim 11, wherein the patient data includes one of a patient medical history and vaccination history.

14. The system of claim 11, wherein the receiver receives a retrieval request message, the retrieval request message indicating patient data to be retrieved from the memory.

15. The system of claim 14, wherein the retrieval request message includes the identification code, the patient data being retrieved based at least in part on the identification code.

16. The system of claim 15, wherein the at least a portion of the identification data is encoded onto the code.

17. A method for imprinting symbology corresponding to patient data, the method comprising:
determining identification data corresponding to a patient;
determining a code to imprint based at least in part on the identification data, at least a portion of the identification data being represented in the code; and
imprinting the code onto the patient.

18. The method of claim 17, further comprising:
receiving patient data; and
transmitting identification data and patient data, the identification data corresponding to patient data.

19. The method of claim 18, further comprising receiving a storage confirmation message, the storage confirmation message indicates the identification data and corresponding patient data are stored at a server.

20. The method of claim 17, wherein the code is at least a one dimensional code.

21. The method of claim 20, wherein the code is based at least, in part, on one of a geographical location of the living creature and date the determined code is imprinted.

22. The method of claim 17, wherein the code is imprinted onto the patient by at least one of a laser based mechanism and needle based injection mechanism.

23. The method of claim 17, wherein the code is at least a two dimensional code.
